(19) United States
(12) Patent Application Publication
(10) Pub. No.: US 2009/0085743 A1
(43) Pub. Date: Apr. 2, 2009

(54) METHODS AND SYSTEMS FOR CONTROLLING OPERATIONS OF A MOBILE RADIO FREQUENCY READER BASED ON ITS LOCATION

(75) Inventors: Ranjith Ravi, San Jose, CA (US); Saurabh Bhargava, San Jose, CA (US); Shilpa Moghe, San Jose, CA (US); Ajay Malik, Santa Clara, CA (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 11/864,280

(22) Filed: Sep. 28, 2007

(51) Int. Cl. G08B 13/14

(52) U.S. Cl. 340/572.1

(57) ABSTRACT

Methods and systems are provided for controlling RF reader operations based the location of the RF reader. One method includes determining that the RF reader is located within a zone associated with an access level and enabling or disabling the RF reader based on the access level. A system includes multiple access ports (APs) defining multiple zones including an access level for the RF reader. The system also includes a switch configured to determine a present zone of the mobile RF reader and enabling the RF reader based on the access level of the present zone. Another system includes means for receiving a signal from an access port and means for determining a location of the RF reader based on the signal, the location associated with an access level. The system also includes means for enabling or disabling the RF reader based on the access level.

### FIELD OF THE INVENTION

The present invention relates generally to radio frequency identification (RFID) systems, wireless local area networks (WLANs), and other such networks incorporating RF tags, and, more particularly, to methods and systems for controlling operations of a mobile RF reader based on the location of the RFID reader.

### BACKGROUND OF THE INVENTION

In recent years, radio frequency identification (RFID) systems have achieved wide popularity in a number of applications, as they provide a cost-effective way to track the location of a large number of assets in real time. In large-scale applications (e.g., warehouses, retail spaces, and the like), many types of tags may exist in the environment (or “site”). Likewise, multiple types of readers, such as RFID readers, active tag readers, 802.11 tag readers, Zigbee tag readers, and the like are typically distributed throughout the environment in the form of entryway readers, conveyer-belt readers, mobile readers, etc., and may be linked by network controller switches and the like.

In many instances it is desirable to know the location of an RFID reader within a building or other such site. Furthermore, it is desirable to control RFID reader access to one or more tags at a particular location, particularly when the information included within the tag(s) is of a sensitive or proprietary nature.

Accordingly, it is desirable to provide systems and methods for controlling operations of a mobile RFID reader based on the location of the RFID reader. Furthermore, other desirable features and characteristics of the present invention will become apparent from the subsequent detailed description and the appended claims, taken in conjunction with the accompanying drawings and the foregoing technical field and background.

### BRIEF SUMMARY OF THE INVENTION

Methods are provided for controlling operations of a mobile radio frequency (RF) reader based on its location. One method comprises the steps of determining that the RF reader is located within a first zone of a plurality of zones, each zone associated with one of a plurality of access levels, and enabling or disabling the RF reader based on a first access level of the first zone.

Various embodiments of the invention also provide systems for controlling operations of a mobile RF reader based on its location. A system comprises a plurality of access ports defining a plurality of zones within a geographic area, wherein each zone is assigned one of a plurality of access levels and each access port is configured to receive data from the mobile RF reader. The system also comprises a switch communicatively coupled to each access port, wherein the switch is configured to determine a present zone of the mobile RF reader based on the data acquired from at least one of the access ports and enable the mobile RF reader based on the access level of the present zone.

Apparatus for controlling operations of a mobile RF reader based on its location are also provided. One apparatus comprises means for receiving a first signal from a first access port in communication with a mobile RF reader and the RF switch, and means for determining a first location of the mobile RF reader based on the first signal, wherein the first location is associated with a first access level. The apparatus also comprises means for enabling or disabling the mobile RF reader based on the first access level.

### BRIEF DESCRIPTION OF THE DRAWINGS

The present invention will hereinafter be described in conjunction with the following drawing FIGURE, and

FIG. 1 is a schematic diagram of one exemplary embodiment of a system for controlling operations of a mobile radio frequency (RF) reader based on its location.

### DETAILED DESCRIPTION OF THE INVENTION

The following detailed description is merely exemplary in nature and is not intended to limit the range of possible embodiments and applications. Furthermore, there is no intention to be bound by any theory presented in the preceding background or the following detailed description.

For simplicity and clarity of illustration, the drawing FIGURE depicts the general structure and/or manner of construction of the various embodiments. Descriptions and details of well-known features and techniques may be omitted to avoid unnecessarily obscuring other features. Elements in the drawing FIGURE are not necessarily drawn to scale: the dimensions of some features may be exaggerated relative to other elements to assist improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein. Unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically.

The terms “comprise,” “include,” “have” and any variations thereof are used synonymously to denote non-exclusive inclusion. The terms “left,” right,” “in,” “out,” “front,” “back,” “up,” “down,” and other such directional terms are used to describe relative positions, not necessarily absolute positions in space. The term “exemplary” is used in the sense of “example,” rather than “ideal.”

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various FIGURES contained herein are intended to represent example functional relationships and/or physical couplings between the various elements. Many alternative or additional functional relationships or physical connections may be present in a practical embodiment.

The present invention generally relates to systems and methods for controlling operation of a mobile RF reader based on the location of the RFID reader. Specifically, the systems and methods assign an operation policy or access level for RFID readers to various zones in a building or other site where access ports have previously been deployed.

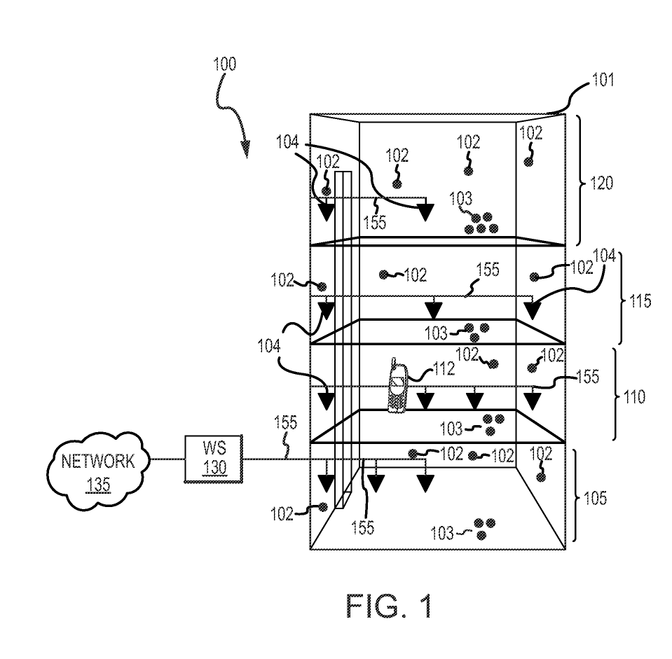

Referring now to FIG. 1, an example environment 101 (e.g., a building or other site) housing a system 100 for controlling operations of a mobile RF reader 112 based on the location of RF reader 112 is illustrated. Note that while FIG. 1 illustrates a three-dimensional, multi-floored building, the invention is not so limited. That is, environment 101 may be any two-dimensional or three-dimensional space within or without a building or other structure. Example environments include, for example, single-story buildings, multi-story buildings, school campuses, commercial buildings, warehouses, and the like structures.

System 100 includes multiple RFID tags 102, 103 (or “tags”), multiple access ports 104 (or “APs”), an RF switch 130 (or “WS”), and a network 135 in communication with one another. Notably, system 100 may also include any number of additional and/or intervening switches, routers, servers and other network components.

Tags 102, 103 may be one or more of various types of tags including, but not limited to, active tags, passive tags, semi-active tags, WiFi tags, 801.11 tags, and the like RFID tags. Note that the term “RFID” is not meant to limit the invention to any particular type of tag. That is, the term “tag” refers, in general, to any RF element that can be communicated with and has an ID (or “ID signal”) that can be read by another component. In general, RFID tags 102, 103 (sometimes referred to as “transponders”) may be classified as either an active tag, a passive tag, or a semi-active tag.

Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

During operation, RFID reader 112 reads one or more tags 102 (or “near-me” tags) when RFID reader 112 is within a predetermined range (e.g., about 0 meters to about 10 meters), which range depends on the particular technology of RFID reader 112 and tags 102. The data transmitted from the tag(s) 102 is then transmitted by RFID reader 112 to one or more APs 104 located within range of the present location of RFID reader 112. By determining which AP(s) 104 RFID reader 112 is communicating with, the location of RFID reader 112 can be determined, as discussed in more detail below.

APs 104 are configured to wirelessly communicate with RFID reader 112 and to provide RFID reader 112 access to network 135 (via RF switch 130). APs 104 also communicate with RF switch 130 via appropriate communication lines 155 (e.g., conventional Ethernet lines, or the like), as is known in the art.

Each AP 104 includes one or more associated antennas, and may incorporate additional functionality, such as filtering, cyclic-redundancy checks (CRC), and tag writing, as is known in the art. Each antenna has an associated RF range, which depends upon, among other things, the power of the respective antenna. The RF range corresponds to the area around the antenna in which an RFID reader may be communicated with by that particular antenna, and may be defined by a variety of shapes and sizes, depending upon the nature of the antenna.

As illustrated in FIG. 1, APs 104 are distributed throughout environment 101 with a density and number that is appropriate given the power of APs 104, as well as the structural details (e.g., internal architecture) of environment 101. That is, APs 104 may be distributed evenly throughout environment 101, or may be clustered in predefined “zones” so that RFID reader 112 is able to communicate with at least one AP 104 throughout environment 101. In the illustrated embodiment, for example, each floor of environment 101 is designated as a zone (e.g., zones 105, 110, 115, and 120). In general, each zone includes at least one AP 104, but may include any number of APs 104, depending upon the size, shape, number of obstacles, or other such factors of a particular zone.

Each of zones 105, 110, 115, and 120 is assigned an access or security level that dictates the operation policy of RFID reader 112 within each particular zone. That is, the access level determines whether RFID reader 112 is able to read tags 102 and/or 103 within a particular zone. For example, in one zone, RFID reader 112 may be able to read “near-me” tags 102, but cannot read RFID tags 103, whereas in another zone RFID reader 112 may be unable to read both “near me” tags 102 and RFID tags 103, and in yet another zone, RFID reader 112 is able to read both “near me” tags 102 and RFID tags 103.

As is known, a particular AP 104 may communicate with multiple RFID readers 112 (e.g., when multiple RFID readers 112 are located within environment 101), and system 100 is not limited to controlling operations of a single RFID reader 112. In addition, each AP 104 may also be configured to couple multiple RFID readers 112 to a single RF switch 130, as illustrated in FIG. 1.

RF switch 130 (alternatively referred to as a “switching device,” “WS,” or simply “switch”) is coupled to network 135 (e.g., a WiFi network coupled to one or more other networks or devices) and to each AP 104. In general, RF switch 130 determines the destination of the packets it receives and routes those packets to network 135 or the appropriate AP 104, and AP 104 then routes the packets to the appropriate device (e.g., RFID reader 112). Thus, each AP 104 acts as a conduit, sending/receiving RF transmissions via RFID reader(s) 112, and sending/receiving packets via a network protocol with RF switch 130.

RF switch 130 may support any number of APs 104 that use wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. As described in further detail below, RF switch 130 includes hardware, software, and/or firmware capable of carrying out the functions described herein. Thus, RF switch 130 may comprise one or more processors accompanied by storage units, displays, input/output devices, an operating system, database management software, networking software, and the like. Such systems are well known in the art, and need not be described in detail.

RF switch 130 may be configured as a general purpose computer, a network switch, or any other such network host. In a preferred embodiment, RF switch 130 is modeled on a network switch architecture, but includes RF network controller software (or “module”) whose capabilities include, among other things, the ability to allow it to configure and monitor RFID reader 112 and its antenna(s).

Locationing of RFID reader 112 generally involves determining which AP 104 or tag 102/103 RFID reader 112 is communicating with at a particular time. In one embodiment, RFID reader 112 is in substantially constant communication with one or more APs 104 when present within zones 105-120. In this embodiment, the received signal strength indicator (RSSI) between RFID reader 112 and the APs 104 is used to determine the location of RFID reader 112. Specifically, locationing of RFID reader 112 involves determining which AP 104 has the strongest RSSI value when communicating with RFID reader 112. That is, system 100 is configured to reconcile the location of RFID reader 112 based on a pre-defined floor map (i.e., a map of the location of APs 104) and/or a zone map where the AP 104 with which RFID reader 112 is positioned. Any such map and zone information may be preloaded, downloaded over network 135, or received from environment 101. Stated another way, the location of each respective AP 104 is preferably known prior to beginning the locationing process; however, this knowledge may be distributed over a number of systems and networks. In a particular embodiment, the placement of each AP 104 is predefined so that a quick understanding of the floor and/or zone can be determined.

In another embodiment, the location of RFID reader 112 is determined based on the tag(s) 102/103 RFID reader 112 is currently reading. Specifically, RF switch 130 is able to determine that RFID reader 112 is located proximate to or within a predetermined distance of the tags 102/103 RFID reader 112 is currently reading.

RF switch 130 is also configured to transmit a signal (via an AP 104) to RFID reader 112 that disables RFID reader 112 or prevents RFID reader 112 from reading RFID tags 103. Specifically, RF switch 130 is configured to disable the read operation of RFID reader 112 when RFID reader 112 is located in a zone assigned an access level prohibiting RFID reader 112 from reading tags 103 within that particular zone.

The following examples may be useful in understanding the operation of system 100. Here, RFID reader 112 is a mobile reader (e.g., a cellular telephone, a WiFi-enabled laptop computer, a PDA, a Palm®, or other similar device) at least temporarily located in zone 110. Furthermore, zones 105 and 110 are assigned access levels that prohibit RFID reader 112 from reading tags 103, while zones 115 and 120 are assigned access levels that enable RFID reader 112 to read tags 103.

In one example, RFID reader 112 is in communication with one or more APs 104 on a substantially constant basis. APs 104 transmits signals to RF switch 130 and one or more of the locationing techniques discussed above is used by RF switch 130 to determine in which zone RFID reader 112 is located. If RFID reader 112 is located in zone 105 or 110, RF switch 130 transmits a command (via AP 104) to RFID reader 112 that disables/prevents RFID reader 112 from reading “near me” tags 102 and RFID tags 103. If RFID reader 112 is located in zone 115 or 120, RF switch 130 do not transmit a command to RFID reader 112 disabling/preventing RFID reader 112 from reading “near me” tags 102 and RFID tags 103. In other words, RFID reader 112 is permitted to read “near me” tags 102 and RFID tags 103.

In another example, RFID reader 112 activates each “near-me” tag 102 and/or tag 103 that RFID reader 112 comes within range of while RFID reader 112 is stationary or while being transported (e.g., by a conveyor belt, a person, a motor vehicle, etc.) through zones 105-120. After reading tag data from a “near-me” tag 102 and/or tag 103, RFID reader 112 transmits (via one or more APs 104 in zones 105-120) the tag data to RF switch 130. The location of RFID reader 112 is determined by identifying the tag with which RFID reader 112 is currently communicating. Once RF switch 130 determines that RFID reader 112 is located in a particular zone, RF switch 130 checks the access level of that zone. If RF switch 130 determines that the access level of the zone (e.g., zone 105 or 110) prohibits RFID reader 112 from reading tags 102/103, RF switch 130 transmits (via an AP 104 in zone 110) a signal to RFID reader 112 that disables RFID reader 112 or prevents RFID reader 112 from reading tags 102/103 located in zone 105 or 110. Specifically, RF switch 130 transmits a command to RFID reader 112 that disables the read operation of RFID reader 112. If RF switch 130 determines that the access level of the zone (e.g., zone 115 or 120) permits RFID reader 112 to read tags 102/103, RF switch 130 do not transmit a signal to RFID reader 112 that disables/prevents RFID reader 112 from reading tags 102/103 located in zone 115 or 120.

It should be appreciated that the example embodiment or embodiments described herein are not intended to limit the scope, applicability, or configuration of the invention in any way. For example, these methods may be used in connection with standard barcode readers and the like. In general, the foregoing detailed description and examples will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

We claim:

1. A method for controlling operations of a mobile radio frequency (RF) reader based on its location, the method comprising the steps of:
determining that the RF reader is located within a first zone of a plurality of zones, each zone associated with one of a plurality of access levels; and
enabling or disabling the RF reader based on a first access level of the first zone.

2. The method of claim 1, wherein the plurality of zones each include a plurality of access ports, the determining step comprising the steps of:
receiving a signal strength indicator from at least one of the plurality of access ports; and
determining that the mobile RF reader is located within the first zone based on each received signal strength indicator.

3. The method of claim 1, further comprising the step of monitoring movement of the mobile RF reader between the plurality of zones.

4. The method of claim 3, further comprising the steps of:
determining that the mobile RF reader is located within a second zone; and
enabling or disabling the mobile RF reader based on a second access level of the second zone.

5. The method of claim 3, further comprising the step of enabling or disabling the mobile RF reader within each zone based on a second access level associated with each respective zone.

6. The method of claim 1, wherein the enabling step comprises the step of enabling the mobile RF reader to read RF tags located within the first zone.

7. The method of claim 6, wherein the disabling step comprises the step of preventing the mobile RF reader from reading the RF tags.

8. A system for controlling a mobile radio frequency (RF) reader within a geographic area, comprising:
a plurality of access ports defining a plurality of zones within the geographic area, each zone assigned one of a plurality of access levels, each access port configured to receive data from the mobile RF reader; and
a switch communicatively coupled to each access port, wherein the switch is configured to:
determine a present zone of the mobile RF reader based on the data acquired from at least one of the plurality of access ports, and
enable the mobile RF reader based on the access level of the present zone.

9. The system of claim 8, wherein the switch is further configured to disable the mobile RF reader based on the access level of the present zone.

10. The system of claim 9, wherein the switch is configured to enable the mobile RF reader to read a RF tag located within a first zone when the switch enables the mobile RF reader.

11. The method of claim 10, wherein the switch is configured to prevent the mobile RF reader from reading the RF tag when the switch disables the mobile RF reader.

12. The system of claim 8, wherein the switch is further configured to:
receive a signal strength indicator from at least one of the plurality of access ports; and
determine that the mobile RF reader is located within the present zone based on each received signal strength indicator.

13. The method of claim 8, wherein the switch is further configured to monitor a movement of the mobile RF reader between the plurality of zones based on the data acquired from at least one of the plurality of access ports.

14. The method of claim 13, wherein the switch is further configured to:
determine that the mobile RF reader is located within a new zone; and
enable or disable the mobile RF reader based on the access level of the new zone.

15. The method of claim 13, wherein the switch is further configured to enable or disable the mobile RF reader within each zone based on the access level of each respective zone.

16. A radio frequency (RF) switch, comprising:
means for receiving a first signal from a first access port in communication with a mobile RF reader and the RF switch;
means for determining a first location of the mobile RF reader based on the first signal, the first location associated with a first access level; and
means for enabling or disabling the mobile RF reader based on the first access level.

17. The RF switch of claim 16, wherein the enabling means comprises means for enabling the mobile RF reader to read an RF tag within the location.

18. The RF switch of claim 17, wherein the disabling means comprises means for preventing the mobile RF reader from reading the RF tag.

19. The RF switch of claim 16, wherein the determining the first location means comprises means for receiving a signal strength indicator from the first access port.

20. The RF switch of claim 16, further comprising:
means for receiving a second signal from a second access port in communication with the mobile RF reader and the RF switch;
means for determining a second location of the mobile RF reader based on the second signal, the second location associated with a second access level for the mobile RF reader; and
means for enabling or disabling the mobile RF reader based on the second access level.
